(19) United States
(12) Patent Application Publication
(10) Pub. No.: US 2026/0254008 A1
(43) Pub. Date: Aug. 27, 2026

(54) SECONDARY BATTERY

(71) Applicant: Samsung SDI Co., Ltd., Yongin-si, Gyeonggi-do (KR)

(72) Inventor: Jae Gyun DOO, Yongin-si (KR)

(21) Appl. No.: 19/161,482

(22) PCT Filed: Mar. 8, 2024
(86) PCT No.: PCT/KR2024/003062

§ 371 Date: Sep. 2, 2025

(30) Foreign Application Priority Data
Feb. 15, 2024 (KR) 10-2024-0021561

(51) Int. Cl. H01M 50/169; B60L 50/60; H01M 50/103; H01M 50/107; H01M 50/15; H01M 50/152

(52) U.S. Cl. CPC H01M 50/169; H01M 50/103; H01M 50/107; H01M 50/15; H01M 50/152; B60L 50/60

(57) ABSTRACT

The present invention relates to a cylindrical secondary battery having a folded portion provided in an opening of a case to prevent a welding portion from breaking due to swelling of the case during welding to a cap plate. As an example, disclosed in the present invention is a secondary battery comprising: an electrode assembly; a case that accommodates the electrode assembly through a space of which a portion is open; and a cap plate that seals the space of the case, wherein a folded portion is formed in the case by being folded along at least one area, and the cap plate may be coupled to the folded portion.

### TECHNICAL FIELD

Embodiments relate to secondary batteries.

### BACKGROUND ART

Unlike primary batteries that are not designed to be (re) charged, secondary (or rechargeable) batteries are batteries that are designed to be discharged and recharged. Low-capacity batteries are packaged in pack form with one battery cell and are used in small portable electronic devices such as mobile phones and camcorders. Large-capacity batteries are battery pack units in which dozens of battery packs are connected, and are used as power sources for driving motors in hybrid cars and electric cars.

Secondary batteries may be formed by embedding an electrode assembly formed by interposing a separator between a positive electrode plate and a negative electrode plate and an electrolyte in a case, and disposing a cap plate in the case. Here, the case and the cap plate block the physical path between the inside and the outside through a process such as crimping or welding.

Meanwhile, when the secondary battery is charged and discharged, the chemical reaction of the positive/negative active materials causes reversible or irreversible expansion in the thickness direction of the electrode plates. As the charge/discharge reaction cycle of the secondary battery progresses, the amount of expansion increases, and the thickness of the electrode assembly increases in the stacking direction of the electrode plates. At this time, the gap between the electrode assembly and the case may decrease, and when the gap disappears, the case may be pushed out and swelled, causing a swelling phenomenon. When the swelling phenomenon occurs, the coupling part of the case and the cap plate, which have weak structural strength, may be broken.

The information disclosed in this section is provided only for enhancement of understanding of the background of the disclosure and therefore it may contain information that does not form the prior art.

### DISCLOSURE

### Technical Problem

The present invention provides a secondary battery having a bent part formed in an opening of a case to prevent a welding part from being broken by the swelling of a case when welding a case and a cap plate.

In addition, the present invention provides a secondary battery in which the strength of the opening of the case increases in proportion to the thickness and length of the welding part by welding the case and the cap plate after folding the bent part formed in the opening of the case.

Also, the present invention provides a secondary battery capable of ensuring a sufficient welding area between an opening of a case and a cap plate compared to the conventional one.

### Technical Solution

A secondary battery according to an embodiment includes an electrode assembly, a case that accommodates the electrode assembly through a partially open space, and a cap plate that seals the space of the case, wherein the case may include a folded portion formed to be folded along at least one area, and the cap plate may be coupled to the folded portion.

The folded portion may be bent toward the inside or outside of the case.

The folded portion may be bent along at least one side of the case.

The folded portion may be folded to cover a portion of an open space of the case.

The folded portion and the cap plate may be coupled by welding.

The cap plate may be formed to extend to cover a region of the folded portion bent toward the outside of the case.

The folded portion may be bent at least once toward the inside of the case.

The folded portion may include a first folded portion bent toward the inside lower side of the case and a second folded portion extended from the first folded portion in a horizontal direction toward the inside of the case.

Both sides of the cap plate may correspond to the shapes of the first folded portion and the second folded portion.

A thickness of the cap plate may be equal to or greater than the fold height folded f in the inner lower direction of the case at the first folded portion.

The case is formed in a pipe shape with one end open, and the folded portion may be folded along the perimeter of the open end of the pipe shape.

The folded portion is cut in at least one region, and the folded portion overlaps in the folded structure.

Or, the folded portion may be formed in at least one of a pair of long side portions or short side portions of the case facing each other.

Or, a width of the folded portion may be smaller than the width of the long side portion or short side portion of the case where the folded portion is formed.

### Advantageous Effects

The secondary battery according to the embodiment includes a case in which a folded portion is formed at an opening. Accordingly, when welding the case and the cap plate, breakage of the welded part due to swelling of the case may be prevent.

In addition, the case and the cap plate are welded after folding the folded portion formed in the opening of the case. Therefore, the strength of the opening of the case may be increased in proportion to the thickness and length of the welding region.

In addition, the welding area between the opening of the case and the cap plate may be secured sufficiently compared to the past.

### DESCRIPTION OF DRAWINGS

FIG. 1a is a perspective view showing a secondary battery according to an embodiment.

FIG. 1b is a cross-sectional view taken along line A-A′ of FIG. 1a.

FIG. 2 is a perspective view showing a case of the secondary battery illustrating FIG. 1a.

FIG. 3 is a perspective view showing a state before the case and cap plate of the secondary battery illustrated in FIG. 1a are coupled.

FIGS. 4a to 4d are perspective views showing various embodiments of the case of the secondary battery illustrated in FIG. 1a.

FIG. 5 is a perspective view showing a cylindrical secondary battery according to various embodiments.

FIG. 6 is a cross-sectional view taken along line B-B′ of FIG. 5.

### MODE FOR INVENTION

Hereinafter, preferable embodiments of the present disclosure will be described in detail with reference to the accompanying drawings.

The embodiments of the present disclosure are provided to more completely describe the present disclosure to those skilled in the art, the following embodiments may be modified into various other forms, and the scope of the present disclosure is not limited to the following embodiments. Rather, these embodiments are provided to make the present disclosure more meaningful and complete, and to fully convey the spirit of the present disclosure to those skilled in the art.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present and the element A and the element B are indirectly connected to each other.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “on” or “above” the other elements or features. Thus, the exemplary term “below” can encompass both an orientation of above and below.

The preferred embodiments of the present invention will be described in detail with reference to the attached drawings so that those with ordinary knowledge in the technical field to which the present invention pertains can easily carry out the present invention.

Here, parts having similar configurations and operations are given the same drawing reference numerals throughout the specification. In addition, when it is said that a part is electrically coupled to another part, this includes not only cases where they are directly connected, but also cases where they are connected with another element in between.

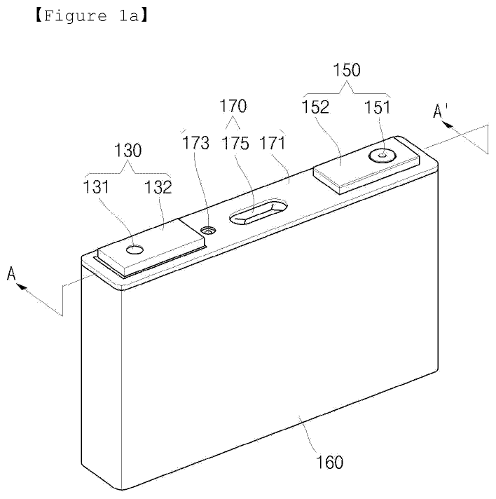

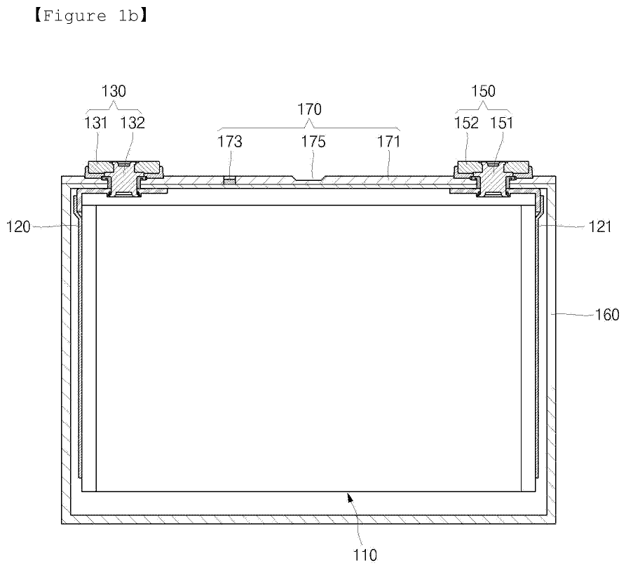

FIG. 1a is a perspective view of a secondary battery according to an embodiment. FIG. 1b is a cross-sectional view taken along line A-A′ of FIG. 1a.

As illustrated in FIGS. 1A and 1B, a secondary battery 100 according to the embodiment of the present invention includes an electrode assembly 110, a first current collector 120 electrically connected to one side of the electrode assembly (e.g., a first electrode tab), a first terminal 130 electrically connected to the first current collector 120, a second current collector 121 electrically connected to the other side of the electrode assembly (e. g., a second electrode tab), a second terminal 150 electrically connected to the second current collector 121, a case 160 that accommodates the electrode assembly, and a cap assembly 170 coupled to an opening of the case 160.

The secondary battery 100 according to the embodiment of the present invention is described as a prismatic lithium ion secondary battery as an example. However, the present invention is not limited thereto, and the present invention may be applied to various types of batteries such as lithium polymer batteries.

The electrode assembly may include a first electrode plate, a second electrode plate, and a separator interposed between the first and second electrode plates. The electrode assembly may be formed by winding or overlapping a laminate of the first electrode plate, the separator, and the second electrode plate formed in a thin plate shape or a film shape. Here, the first electrode plate may operate as a positive electrode and the second electrode plate may operate as a negative electrode, or conversely, the first electrode plate may operate as a negative electrode and the second electrode plate may operate as a positive electrode. However, for the convenience of explanation, the present invention is described as an example in which the first electrode plate operates as a positive electrode and the second electrode plate operates as a negative electrode.

The first electrode plate is formed by coating a first electrode active material such as a transition metal oxide on a first electrode current collector formed of a metal foil such as aluminum or an aluminum alloy, and may include a first electrode tab (or a first uncoated portion) which is a region where the first electrode active material is not coated. The first electrode tab serves as a passage for current flow between the first electrode plate and the first current collector 120.

The second electrode plate is formed by coating a second electrode active material such as a transition metal oxide on a second electrode current collector formed of a metal foil such as copper or nickel, and may include a second electrode tab (or a second uncoated portion) which is a region where the second electrode active material is not coated. The second electrode tab serves as a passage for current flow between the second electrode plate and the second current collector 121.

The separator is positioned between the first electrode plate and the second electrode plate to prevent short circuit and enable movement of lithium ions, and is made of polyethylene or a composite film of polyethylene and polypropylene.

The electrode assembly is accommodated in the case 160 together with, for example, but not limited to, an electrolyte. The electrolyte may be made of a lithium salt such as LiPF6 or LiBF4 in an organic solvent such as EC, PC, DEC, EMC, or DMC. In addition, the electrolyte may be liquid, solid, or gel.

The first terminal 130 is electrically connected to the first electrode tab of the electrode assembly through the first current collector 120. The first terminal 130 may include a first terminal pillar 131 penetrating the cap plate 171 of the cap assembly 170, and the first current collector 120 is electrically connected to the first terminal pillar 131 inside the case 160. Furthermore, the first electrode tab of the electrode assembly is electrically connected to the first current collector 120. In addition, the first terminal 130 includes a first terminal plate 132 (for example, made of aluminum) positioned on the cap plate 171 and coupled to the first terminal pillar 131. Here, the first terminal pillar 131, the first terminal plate 132, and the first current collector 120 are electrically insulated from the cap plate 171. In addition, the cap plate 171 and the case 160 may have the same polarity as the first terminal 130. That is, the case 160 and the cap plate 171 may be positive electrodes.

In addition, the first terminal 130 is only an example for understanding the embodiment of the present invention, and those skilled in the art will understand that the first terminal 130 may be modified into various shapes/structures.

The second terminal 150 is electrically connected to the second electrode tab of the electrode assembly through the second current collector 121. The second terminal 150 may include a second terminal pillar 151 penetrating the cap plate 171 of the cap assembly 170, and the second current collector 121 is electrically connected to the second terminal pillar 151 inside the case 160. Furthermore, the second electrode tab of the electrode assembly is electrically connected to the second current collector 121. In addition, the second terminal 150 includes a second terminal plate 152 (for example, made of aluminum) positioned on the cap plate 171 and coupled to the second terminal pillar 151. Here, the second terminal pillar 151, the second terminal plate 152, and the second current collector 121 are electrically insulated from the cap plate 171.

In addition, the second terminal 150 is only an example for understanding the embodiment of the present invention, and those skilled in the art will understand that the second terminal 150 may be modified into various shapes/structures.

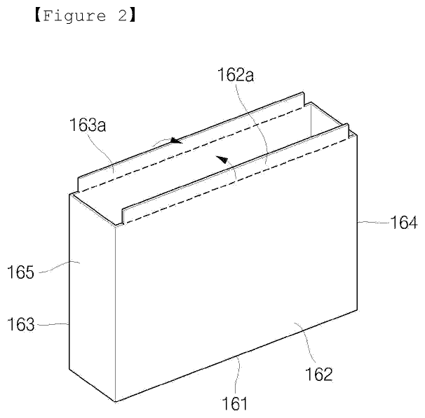

The case 160 may have an approximately rectangular parallelepiped shape with an opening formed at the top and a hollow interior. Through this opening, the electrode assembly may be inserted into the interior of the case 160. In addition, the first current collector 120 and the second current collector 121 may also be located inside the case 160. Referring to FIG. 2, the case 160 may include a rectangular bottom portion 161 having long sides and short sides, long side portions 162 and 163 that are bent and extended from each long side of the bottom portion 161 toward the cap assembly 170, and short side portions 164 and 165 that are extended from each short side and long side portion 162 and 163 of the bottom portion 161.

The cap assembly 170 may include a cap plate 171 in the form of a flat plate. That is, the cap plate 171 is made of a thin plate material and is coupled to the opening of the case 160 to seal the opening. In addition, the cap plate 171 includes an electrolyte injection part that injects electrolyte into the interior of the sealed case 160, and the electrolyte injection part is sealed by a sealing plug after the electrolyte is injected. In addition, the cap plate 171 includes a vent hole, and a vent plate 173 that breaks when the internal pressure of the sealed case 160 exceeds a set pressure is installed in the vent hole.

The cap plate 171 is welded to the opening of the case 160 to seal the opening.

Since such the secondary battery 100 has both a negative electrode and positive electrode on the upper surface, when a plurality of cylindrical secondary batteries 100 are electrically connected through a bus bar, the bus bar connection structure may be simplified since they only need to be connected on the upper surface.

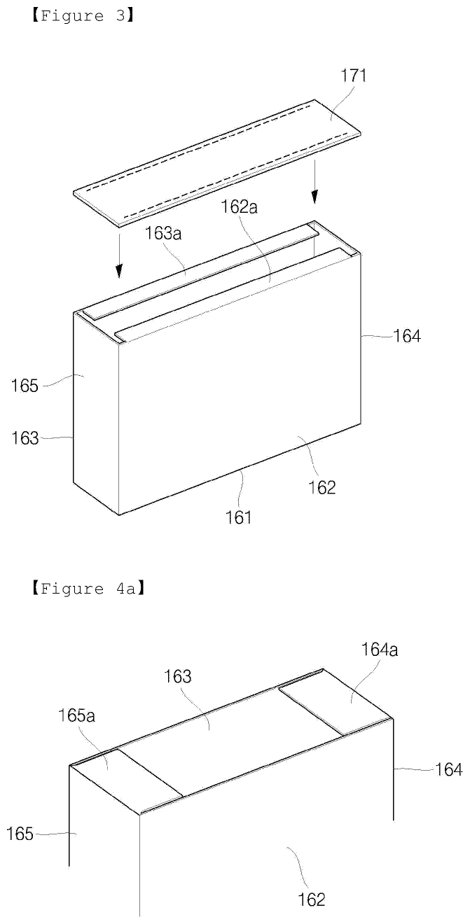

FIG. 2 is a perspective view showing the case of the secondary battery illustrated in FIG. 1a, and FIG. 3 is a perspective view showing the state before the case and the cap plate of the secondary battery illustrated in FIG. 1a are coupled.

In the present invention, in order to secure a welding area when welding the cap plate 171 and the case 160, a folded portion is formed by folding along at least one region of the case 160. First, the folded portion may be folded toward the inside or outside of the case 160. This folded portion may be formed by folding along at least one side of the case 160. For example, the folded portion may be fixed to a bending machine or a press mold and then folded into a predetermined shape.

For example, as illustrated in FIGS. 2 and 3, the folded portion 162a and 163a is formed to extend upwardly from the long side portions 162 and 163 of the case 160 and is bent inwardly of the case 160, and the upper surface of the folded portion 162a and 163a may be welded to the cap plate 171. In addition, the folded portion 162a and 163a may be formed to extend from the long side portions 162 and 163 of the case 160, and the extended region may be formed by folding toward the outside of the case 160. Here, the cap plate 171 may be formed to extend so as to cover the region of the folded portion 162a and 163a that is bent toward the outside of the case 160 for welding with the folded portion 162a and 163a. Through this, it is possible to prevent the fracture of the welding part due to swelling of the case 160. At this time, the folded portion 162a and 163a is illustrated as being formed on the long side portion 162 of the case 160, and the widths of the folded portions 162a and 163a may be smaller than the widths of the long side portions 162. Therefore, the bending operation of the folded portion 162a and 163a may not be hindered by the long side portion 162.

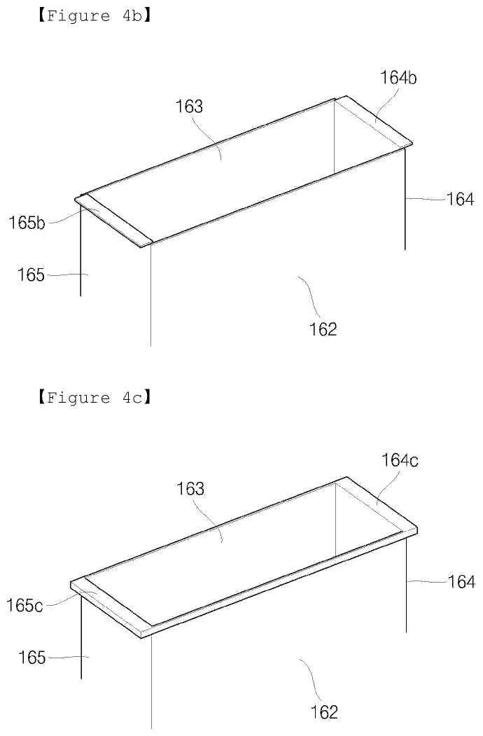

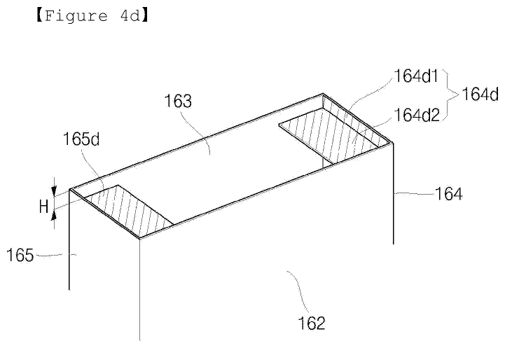

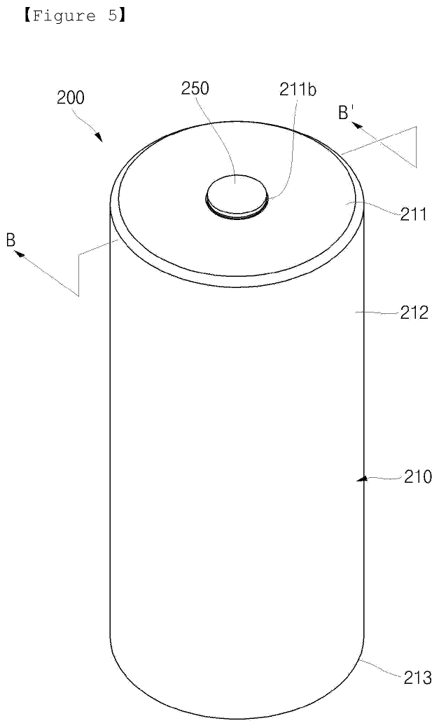

FIGS. 4a to 4d are perspective views showing various embodiments of the case of the secondary battery illustrated in FIG. 1A.

As illustrated in FIG. 4A, the folded portions 164a and 165a may be formed by folding toward the inside of the case 160 to cover a portion of an open space of the case 160. That is, the folded portions 164a and 165a are formed by extending from the short side portions 164 and 165 of the case 160, and the extended region is formed by folding toward the inside of the case 160. [62] As illustrated in FIGS. 4B to 4C, the folded portions 164b 165b, 164c and 165c may be formed by folding toward the outside of the case 160. That is, the folded portions 164b, 165b, 164c and 165c are formed by extending from the short side portions 164 and 165 of the case 160, and the extended region is formed by folding toward the outside of the case 160. In order to weld the cap plate 171 and the folded portion 164b, 165b, 164c and 165c, the cap plate may be formed to extend to cover the region of the folded portion 164b, 165b, 164c and 165c bent toward the outside of the case 160. In addition, the folded portions 164b, 165b, 164c and 165c may be formed by extending from the short side portions 164 and 165 of the case 160, and the extended region may be formed by folding toward the inside of the case 160.

As illustrated in FIG. 4d, the folded portions 164d and 165d are formed to extend from the short side portions 164 and 165 of the case, and the extended region may be bent at least once toward the inside of the case 160. The folded portions 164d and 165d may include a first folded portion 164d1 bent toward the inner lower side of the case 160 and a second folded portion 164d2 extended from the first folded portion 164d1 toward the inner horizontal direction of the case 160. Here, both sides of the cap plate 171 may be formed to correspond to the shapes of the first folded portion 164d1 and the second folded portion 164d2 for welding with the folded portions 164d and 165d. In addition, the thickness of the cap plate 171 may be equal to or greater than the folding height H that is bent in the inner lower direction of the case 160 at the first folded portion 164d1.

In this way, since one embodiment of the present invention folds the folded portion formed in the opening of the case 160 and then welds it with the cap plate 171, the welding area of the opening of the case 160 and the cap plate 171 may be secured sufficiently compared to the past. In addition, the strength of the opening of the case 160 may be increased in proportion to the thickness and length of the welded part.

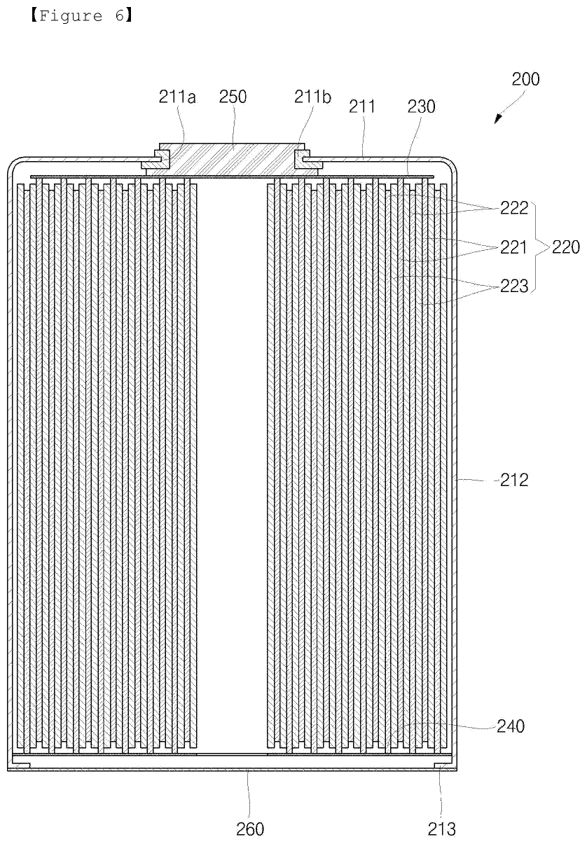

FIG. 5 is a perspective view showing a cylindrical secondary battery according to various embodiments of the present invention, and FIG. 6 is a cross-sectional view showing a cross-section of the cylindrical secondary battery illustrated in FIG. 5 along line A-A′.

As shown in FIGS. 5 and 6, the cylindrical secondary battery 200 according to various embodiments of the present invention may include a cylindrical case 210, an electrode assembly 220 accommodated in the cylindrical case 210, a rivet terminal 250 coupled to a terminal hole provided at one end of the cylindrical case 210, and a cap plate 260 sealing an opening at the other end of the cylindrical case 210.

The cylindrical case 210 includes a circular upper surface 211, a side surface 212 extending downward from an edge of the upper surface 211 by a predetermined length, and a folded surface 213 extending inward from an end of the side surface 212 by a predetermined length and folded. The upper surface 211, the side surface 212, and the folded portion 213 of the cylindrical case 210 may be formed as an integral body.

The circular upper surface 211 may have a flat circular plate shape and may have a terminal hole 211a penetrating the center. The rivet terminal 250 may be coupled by inserting it into the terminal hole 211a of the upper surface 211. A first gasket 211b for sealing and electrical insulation may be further interposed between the terminal hole 211a and the rivet terminal 250. The first gasket 211b may block contact between the rivet terminal 250 and the cylindrical case 210, thereby electrically separating them. The terminal hole 211a of the upper surface 211 of the cylindrical case 210 may be sealed by the first gasket 211b. The first gasket 211b may be formed of a resin material such as polyethylene (PE), polypropylene (PP), polyethylene terephthalate (PET), etc.

In addition, the folded portion 213 is formed by being folded inwardly of the cylindrical case 210 by a certain length. At this time, the folded portion 213 may be formed by being folded only by a certain length to form a space into which the electrode assembly 220 may be inserted. The end of the folded portion 213 is welded to a cap plate 260. In addition, a cut portion may be formed in a predetermined region of the folded portion to facilitate folding and prevent wrinkles from occurring during sealing.

The bottom of the cylindrical case 210 is open during the manufacturing process of the cylindrical secondary battery 200. Therefore, the electrode assembly 220 may be inserted through the open bottom of the cylindrical case 210 together with the electrolyte during the manufacturing process. After the open bottom of the cylindrical case 210 is placed facing upward, the electrolyte and electrode assembly 220 may be inserted. After the electrolyte and electrode assembly 220 are inserted, the cap plate 260 may be coupled to the open bottom of the cylindrical case to seal the interior of the cylindrical case 210. The electrolyte serves to enable lithium ions to move between the positive electrode plate 221 and the negative electrode plate 222 constituting the electrode assembly 220. The electrolyte may be a non-aqueous organic electrolyte that is a mixture of a lithium salt and a high-purity organic solvent. In addition, the electrolyte may be a polymer using a polymer electrolyte or a solid electrolyte, and the type of the electrolyte is not limited.

The cylindrical case 210 may be formed of steel, a steel alloy, aluminum, an aluminum alloy, or an equivalent thereof, but the material is not limited.

The electrode assembly 220 includes the positive electrode plate 221 coated with a positive electrode active material, the negative electrode plate 222 coated with a negative electrode active material, and the separator 223 interposed between the positive electrode plate 221 and the negative electrode plate 222 to prevent a short circuit between the positive electrode plate 221 and the negative electrode plate 222 and to allow only the movement of lithium ions. The electrode assembly 220 is wound from a winding start end after the positive electrode plate 221, the negative electrode plate 222, and the separator 223 are laminated, and then wound into a cylindrical shape. In addition, a positive electrode uncoated portion not coated with a positive electrode active material may protrude from the positive electrode plate 221 in the upper direction of the electrode assembly 220, and a negative electrode uncoated portion not coated with a negative electrode active material may protrude from the negative electrode plate 222 in the lower direction of the electrode assembly 220.

The positive electrode plate 221 includes a positive electrode current collector, which is a plate-shaped metal foil made of aluminum (Al), and a positive electrode active material made of a transition metal oxide is coated on at least one surface of the positive electrode current collector. In addition, the positive electrode uncoated portion, which is not coated with the positive electrode active material, may be formed on the upper portion of the positive electrode plate 221. The positive electrode uncoated portion may protrude upward from the electrode assembly 220. That is, the positive electrode uncoated portion may protrude further upward than the negative electrode plate 222 and the separator 223.

The negative electrode plate 222 includes a negative electrode current collector, which is a plate-shaped metal foil made of copper (Cu) or nickel (Ni), and a negative electrode active material, such as graphite or carbon, is coated on at least one surface of the negative electrode current collector. In addition, the negative electrode uncoated portion, which is not coated with the negative electrode active material, may be formed on the lower portion of the negative electrode plate 222. The negative electrode uncoated portion may protrude downwardly from the electrode assembly 220. That is, the negative electrode uncoated portion may protrude downwardly more than the positive electrode plate 221 and the separator 223.

The separator 223 may be polyethylene (PE) or polypropylene (PP), but is not limited thereto. The separator may prevent an electrical short between the positive electrode plate 221 and the negative electrode plate 222, and may only allow the movement of lithium ions.

The positive electrode collector plate 230 may be a circular metal plate having a shape corresponding to the upper surface of the electrode assembly 220. The planar size of the positive electrode collector plate 230 may be equal to or smaller than the size of the upper surface of the electrode assembly 220. The positive electrode collector plate 230 may be made of aluminum (Al). In a state where the lower surface of the positive electrode collector plate 230 is in contact with the upper surface of the electrode assembly 220, the positive electrode collector plate may be fixed and electrically connected to the positive electrode plate 221 exposed to the upper portion of the electrode assembly 220 by welding. In a state where the upper surface of the positive electrode collector plate 230 is in contact with the lower surface of the rivet terminal 250, the positive electrode collector plate may be fixed and electrically connected to the rivet terminal 250 by welding. The positive electrode collector plate 230 serves as passage for current flow between the positive electrode plate 221 of the electrode assembly 220 and the rivet terminal 250.

The negative electrode collector plate 240 has a circular flat plate shape corresponding to the lower surface of the electrode assembly 220. The upper surface of the negative electrode collector plate 240 MAY be in contact with the lower surface of the electrode assembly 220. In a state where the upper surface of the negative electrode collector plate 240 is in contact with the lower surface of the electrode assembly 220, the negative electrode collector plate may be fixed and electrically connected to the negative electrode plate 222 exposed to the lower portion of the electrode assembly 220 by welding. The edge of the negative electrode collector plate 240 may be welded in a state of being in contact with the inner surface of the can 212, and fixed and electrically connected to the cylindrical case 210. The inner surface of the can 212 may be the inner surface of the cylindrical case 210. Therefore, the negative electrode current collector plate 240 serves as a passage for current flow between the negative electrode plate 222 of the electrode assembly 220 and the cylindrical case 210.

The rivet terminal 250 may be inserted into the terminal hole 211a formed in the upper surface 211 of the cylindrical case 210 and electrically connected to the positive electrode current collector plate 230. The rivet terminal 250 may be made of the same or similar material as the positive electrode current collector plate 230 and the positive electrode plate 221. The diameter of the rivet terminal of the portion exposed to the upper part of the cylindrical case 210 and the diameter of the rivet terminal located inside the cylindrical case 210 may be larger than the diameter of the rivet terminal located in the terminal hole 211a. For convenience, the portion exposed to the upper portion of the cylindrical case 210 is referred to as the upper end of the rivet terminal, and the portion located inside the cylindrical case 210 and facing the electrode assembly 220 is referred to as the lower end of the rivet terminal. The rivet terminal 250 is coupled to the terminal hole 211a of the upper surface 211 of the cylindrical case 210 from the bottom to the top. Then, the upper end may be compressed and deformed (compressed and molded) by a processing method such as pressing or spinning to be closely attached to the upper surface 211. At this time, the first gasket 211b is interposed between the rivet terminal 250 and the terminal hole 211a, so as to insulate and seal between the rivet terminal 250 and the cylindrical case 210. The rivet terminal 250 may be electrically connected to the positive electrode plate 221 of the electrode assembly 220 through the positive electrode current collector plate 230.

The cap plate 260 is a circular metal plate, and may be coupled to the lower surface of the folded portion 213 of the cylindrical case 210 by welding. By coupling the folded portion 213 of the cylindrical case 210 and the cap plate 260, the welding area between the opening of the cylindrical case 210 and the cap plate 260 may be secured sufficiently compared to the conventional welding area. In addition, the strength of the opening of the cylindrical case 210 may be increased in proportion to the thickness and length of the welded part.

Alternatively, the cap plate 260 may be coupled with the folded portion 213 of the cylindrical case 210 with the second gasket interposed therebetween, thereby preventing the cap plate and the cylindrical case 210 from being electrically connected. Accordingly, the cap plate 260 may not be electrically connected to the positive or negative electrode of the electrode assembly 220, and thus may not have a separate polarity. The second gasket may be formed of a resin material, such as polyethylene (PE), polypropylene (PP), or polyethylene terephthalate (PET). The second gasket may pressurize and seal between the cylindrical case 210 and the cap plate 260, and may prevent the cap plate 260 from being separated from the cylindrical case 210.

The cap plate 260 may be coupled to the folded portion 213 of the cylindrical case 210 by welding and may seal the inside of the cylindrical case 210. A notch may be formed in the cap plate so that the cap plate 260 may be opened at a set pressure. When the internal pressure of the cylindrical case 210 exceeds the broken pressure, the notch is broken to prevent the cylindrical secondary battery 200 from exploding. That is, when excessive internal pressure occurs inside the cylindrical case 210, the notch may be broken to discharge the excessive internal pressure. The notch of the cap plate 260 may be spaced apart from the center and have a ring shape in a plane. Alternatively, the notch may be formed to have a plurality of patterns, but the shape of the notch is not limited.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

1. A secondary battery comprising;
an electrode assembly;
a case that accommodates the electrode assembly through a partially open space; and
a cap plate that seals the space of the case,
wherein the case comprises a folded portion formed to be folded along at least one area, and the cap plate may be coupled to the folded portion.

2. The secondary battery as claimed in claim 1, wherein the folded portion is bent toward the inside or outside of the case.

3. The secondary battery as claimed in claim 1, wherein the folded portion is bent along at least one side of the case.

4. The secondary battery as claimed in claim 2, wherein the folded portion is folded to cover a portion of an open space of the case.

5. The secondary battery as claimed in claim 1, wherein the folded portion and the cap plate is coupled by welding.

6. The secondary battery as claimed in claim 2, wherein the cap plate is formed to extend to cover a region of the folded portion bent toward the outside of the case.

7. The cylindrical secondary battery as claimed in claim 2, wherein the folded portion is bent at least once toward the inside of the case.

8. The secondary battery as claimed in claim 2, wherein the folded portion comprises a first folded portion bent toward the inside lower side of the case and a second folded portion extended from the first folded portion in a horizontal direction toward the inside of the case.

9. The secondary battery as claimed in claim 8, wherein both sides of the cap plate correspond to the shapes of the first folded portion and the second folded portion.

10. The secondary battery as claimed in claim 8, wherein a thickness of the cap plate may be equal to or greater than the fold height folded in the inner lower direction of the case at the first folded portion.

11. The secondary battery as claimed in claim 1, wherein the case is formed in a pipe shape with one end open, and the folded portion is folded along the perimeter of the open end of the pipe shape.

12. The secondary battery as claimed in claim 11, wherein the folded portion is cut in at least one region, and the folded portion overlaps in the folded structure.

13. The secondary battery as claimed in claim 1, wherein the folded portion is formed in at least one of a pair of long side portions or short side portions of the case facing each other.

14. The secondary battery as claimed in claim 13, wherein a width of the folded portion is smaller than the width of the long side portion or short side portion of the case where the folded portion is formed.
